(19) United States
(12) Patent Application Publication
(10) Pub. No.: US 2026/0098436 A1
(43) Pub. Date: Apr. 9, 2026

(54) OPENING AND CLOSING BODY CONTROL APPARATUS AND OPENING AND CLOSING BODY

(71) Applicant: AISIN CORPORATION, Kariya (JP)

(72) Inventors: Mizuya SAKAMOTO, Jiangsu (CN); Linyu SHENG, Jiangsu (CN); Jianwei YU, Jiangsu (CN); Chengjun PIAO, Jiangsu (CN); Sheng WANG, Jiangsu (CN)

(73) Assignee: AISIN CORPORATION, Kariya (JP)

(21) Appl. No.: 19/347,863

(22) Filed: Oct. 2, 2025

(30) Foreign Application Priority Data
Oct. 9, 2024 (CN) 202422435155.X
Sep. 24, 2025 (CN) 202511374234.7

(51) Int. Cl. E05F 15/622

(52) U.S. Cl. CPC E05F 15/622; E05Y 2900/531

(57) ABSTRACT

An opening and closing body control apparatus and an opening and closing body are provided, a plurality of components can be driven by only a single motor, and miniaturization of the device and reduction of costs can be implemented. The opening and closing body control apparatus includes an opening and closing device, a suction closer device, and a driving device that drives the opening and closing device and suction device by the same power source. The driving device utilizes the driving force transmitted from the power source to sequentially perform the suction releasing action of the suction closer device and the opening action of the opening and closing device, or to sequentially perform the closing action of the opening and closing device and the suction action of the suction closer device.

### FIELD OF THE DISCLOSURE

The present disclosure relates to an opening and closing body control apparatus and an opening and closing body comprising the opening and closing body control apparatus.

### BACKGROUND ART

Hitherto, for an opening and closing body of a moving body, such as an automatic door of a vehicle, the following opening-closing mechanism for an automatic door is disclosed in Patent Document 1. The opening-closing mechanism for an automatic door includes a driving device with a driving motor, a screw rod, a nut block, and a push rod hinged to the vehicle body. The driving device drives the screw rod to rotate, and the nut block performs reciprocating linear motion along the screw rod at the same time. The nut block transmits a driving force from the driving motor to the push rod, and the opening and closing of the vehicle door relative to the vehicle body is achieved by the push rod.

### PRIOR ART DOCUMENTS

### Patent Documents

Patent Document 1: China Invention Patent Application Publication No. CN109281568A.

However, in addition to the opening and closing actions, the opening and closing body also needs to perform a suction action to adhere to a vehicle body. Therefore, in addition to the opening-closing mechanism of Patent Document 1, the opening and closing body control apparatus also needs to have a suction closer device such as an automatic door closer. Because each of these devices has a power source such as a motor, the entire opening and closing body control apparatus is enlarged. In addition, due to the high cost of each component with its own motor, it also leads to the problem of overall high cost of the opening and closing body system.

### SUMMARY

Therefore, one objective of the present disclosure is to provide an opening and closing body control apparatus that can drive a plurality of components by only a single power source, thereby implementing miniaturization of the device and reduction of costs. Another objective of the present disclosure is to provide an opening and closing body comprising the opening and closing body control apparatus.

In order to achieve the above objective, an embodiment of the present disclosure is to provide an opening and closing body control apparatus, including: an opening and closing device, wherein the opening and closing device can perform an opening action or a closing action, allowing an opening and closing body of a moving body to open or close relative to a main body of the moving body; a suction closer device, wherein the suction closing device can perform a suction action or a suction releasing action, allowing the opening and closing body adhere to the main body or release the adherence of the opening and closing body relative to the main body; and a driving device, wherein the driving device is connected to the opening and closing device and the suction closer device, and drives the opening and closing device and the suction closer device to perform an action by the same power source, wherein the driving device utilizes a driving force transmitted from the power source to sequentially perform the suction releasing action of the suction closer device and the opening action of the opening and closing device, or to sequentially perform the closing action of the opening and closing device and the suction action of the suction closer device.

According to this structure, a single motor can be used to drive the opening and closing device and the suction closer device to respectively perform the opening and closing actions and the locking and suction releasing actions of the opening and closing body. Because only needs to provide one power source, the overall opening and closing body control apparatus can be miniaturized, and the cost of parts can be reduced. In this way, the total cost of the opening and closing body control apparatus can be reduced.

In this embodiment, preferably, the driving device comprises: a screw rod, wherein the screw rod is connected to an output shaft of the power source and rotates by a driving force transmitted from the power source; a nut block, wherein the nut block is provided on the screw rod, and when the screw rod rotates, the nut block performs reciprocating linear motion along the screw rod; a suction slider, wherein the suction slider is connected to the suction closer device, and drives the suction closer device to perform the suction action or the suction releasing action by the movement of the suction slider; a first engaging mechanism, wherein the first engaging mechanism is connected to the opening and closing device, and is connected to the nut block in a manner capable of being engaged with or disengaged from the nut block, and when the first engaging mechanism is engaged with the nut block, the driving force is transmitted to the opening and closing device; and a second engaging mechanism, wherein the second engaging mechanism abuts against the suction slider, and is connected to the nut block in a manner capable of being engaged with or disengaged from the nut block, and when the second engaging mechanism is engaged with the nut block, the nut block can drive the suction slider to move.

According to this structure, the transmission of the driving force to the opening and closing device and the suction device can be achieved through a simple structure using a driving device which has a screw rod, nut block, suction slider, first engaging mechanism, and second engaging mechanism.

In this embodiment, preferably, the first engaging mechanism includes a first guide rail and a first pawl that can slide rotatably along the first guide rail, and the first pawl can be engaged with or disengaged from the nut block. The second engaging mechanism includes a second guide rail and a second pawl that can slide rotatably along the second guide rail, and the second pawl can be engaged with or disengaged from the nut block.

According to this structure, the transmission to the engaging mechanism can be implemented by using a simple structure.

In this embodiment, preferably, the nut block includes: a moving portion, wherein the moving portion moves along the screw rod; a first protrusion, wherein the first protrusion protrudes from the moving portion toward the first engaging mechanism for the first pawl to be engaged with or disengaged from the first pawl; and a second protrusion, wherein the second protrusion protrudes from the moving portion toward the second engaging mechanism for the second pawl to be engaged with or disengaged from the second pawl.

According to this structure, the transmission to the engaging mechanism can be implemented by using a simple structure.

In this embodiment, preferably, the nut block can move along the screw rod among a first position, a second position, and a third position. When the nut block is located at the first position, the first pawl is engaged with the nut block and is located at one end of a stroke of the first pawl, and the second pawl is not engaged with the nut block and is located at one end of a stroke of the second pawl. When the nut block is located at the second position, the first pawl begins to be disengaged from the nut block and is at the other end of the stroke of the first pawl, and the second pawl begins to be engaged with the nut block and is at the one end of the stroke of the second pawl. When the nut block is located at the third position, the first pawl is not engaged with the nut block and is at the other end of the stroke of the first pawl, and the second pawl is engaged with the nut block and is at the other end of the stroke of the second pawl.

According to this structure, the opening and closing body can sequentially perform a closing action and a suction action, or sequentially perform a suction releasing action and an opening action.

In this embodiment, preferably, an axis of the output shaft of the power source and an axis of the screw rod are located on the same straight line.

According to this structure, the driving force from the power source can be transmitted by using a simple structure.

In this embodiment, preferably, the driving device further includes a gear transmission part, the gear transmission part is arranged at an axial end of the screw rod and is connected to the output shaft of the power source, and the driving force of the power source is transmitted to the screw rod via the gear transmission part. An axis of the output shaft of the power source is parallel to an axis of the screw rod.

According to this structure, the degree of freedom in arranging the power source can be improved.

In this embodiment, preferably, the power source and the suction slider are arranged on the same side of the screw rod in an up-down direction of the moving body.

According to this structure, the space on one side of the screw rod can be fully utilized, so that the layout of the opening and closing body control apparatus can be more compact.

In this embodiment, preferably, the power source and the suction slider are respectively arranged on both sides of the screw rod in an up-down direction of the moving body.

According to this structure, it is possible to effectively prevent the power source from interfering with other components or affecting the operation of other components.

In this embodiment, preferably, the screw rod includes a first screw rod and a second screw rod whose axes are parallel to each other, the gear transmission part includes a first gear transmission part provided at one axial end of the first screw rod and the second screw rod and a second gear transmission part provided at the other axial end of the first screw rod and the second screw rod, the output shaft of the power source is connected to the first gear transmission part, and the driving force of the power source is transmitted to the first screw rod via the first gear transmission part, and then transmitted to the second screw rod via the second gear transmission part, the nut block includes a first nut block provided on the first screw rod and a second nut block provided on the second screw rod, one of the first nut block and the second nut block can be engaged with the first engaging mechanism, and the other one of the first nut block and the second nut block can be engaged with the second engaging mechanism.

According to this structure, the double-screw-rod structure can be used to make the opening and closing body sequentially perform a closing action and a suction action, or sequentially perform an suction releasing action and an opening action.

In this embodiment, preferably, the gear ratios of the first gear transmission part and the second gear transmission part are different, or at least one of the length and thread pitch of the second screw rod is different from that of the first screw rod.

According to this structure, by setting gear transmission parts with different gear ratios, or setting screw rods with different lengths and thread pitches, the driving force can be sequentially transmitted to the opening and closing device and the suction device.

In this embodiment, preferably, the opening and closing device comprises a push rod, one end of the push rod is hinged to the main body, when a force is applied to the push rod toward or away from the main body, a reaction force from the main body is used to open or close the opening and closing body, and a push block is fixed to the push rod, and the push block is connected to the first engaging mechanism via a cable. The driving force is transmitted to the push rod through the cable and the push block.

According to this structure, the opening and closing of the opening and closing body can be implemented by using a simple structure.

In this embodiment, preferably, the other end of the push rod is directly fixed to the first engaging mechanism.

According to this structure, the opening and closing body control apparatus can be made more compact, and the cost can be further reduced.

In this embodiment, preferably, the driving device further includes a housing, and the housing accommodates the power source, the screw rod, the nut block, the suction slider, the first engaging mechanism, and the second engaging mechanism. A part of the push rod extends into the interior of the housing.

According to this structure, space can be further saved, and the opening and closing body control apparatus can be more compact and miniaturized.

In this embodiment, preferably, the driving device includes: a screw rod, wherein the screw rod is connected to the power source and rotates by a driving force transmitted from the power source, a nut block, wherein the nut block is provided on the screw rod, and when the screw rod rotates, the first nut block performs reciprocating linear motion along the screw rod; a transmission slider, wherein the transmission slider is sleeved on the screw rod so as to be freely slidable thereon; a suction slider, wherein the suction slider is connected to the suction closer device, and drives the suction closer device to perform the suction action or the suction releasing action by the movement of the suction slider; an engaging mechanism, wherein the engaging mechanism is connected to the opening and closing device, and is connected to the nut block in a manner capable of being engaged with or disengaged from the nut block, and when the engaging mechanism is engaged with the nut block, the driving force is transmitted to the opening and closing device, ; and a transmission arm, wherein one end of the transmission arm is hinged to the transmission slider, and the other end of the transmission arm is hinged to the suction slider, when the nut block moves and abuts against the transmission slider, the transmission slider moves along the screw rod together with the nut block, and the driving force is transmitted from the transmission slider to the suction slider through the transmission arm, and when the nut block moves away from the transmission slider, the transmission slider is returned due to a restoring force.

According to this structure, by using a transmission slider and a transmission arm, the opening and closing device and the suction closer device can be driven by the driving force of a single motor to respectively perform the opening and closing actions and the unlocking and suction actions of the opening and closing body. The opening and closing body control apparatus can be miniaturized as a whole, especially making the opening and closing body control apparatus more compact in the vertical direction relative to the screw rod, so that the cost of parts and components can be reduced, and the total cost of the opening and closing body control apparatus can be further reduced.

Another embodiment of the present invention is to provide an opening and closing body having the opening and closing body control apparatus.

According to the present disclosure, the opening and closing body control apparatus can drive a plurality of components by only a single power source, so that miniaturization of the opening and closing body control apparatus and reduction of costs can be implemented.

### BRIEF DESCRIPTION OF DRAWINGS

FIG. 1 is a schematic diagram of an opening and closing body control apparatus of a first embodiment, showing the opening and closing body control apparatus when an opening and closing body is in an open state with a maximum opening.

FIG. 2 is a schematic diagram of an opening and closing body control apparatus of the first embodiment, showing the opening and closing body control apparatus when an opening and closing body is in a state where it is closed and not adhered to vehicle body.

FIG. 3 is a schematic diagram of an opening and closing body control apparatus of the first embodiment, showing the opening and closing body control apparatus when an opening and closing body is in a state where it is closed and adhered to vehicle body.

FIG. 4 is a schematic diagram of an opening and closing body control apparatus of a second embodiment.

FIG. 5 is a schematic diagram of an opening and closing body control apparatus of a third embodiment.

FIG. 6 is a schematic diagram of an opening and closing body control apparatus of a fourth embodiment.

FIG. 7 is a schematic diagram of an opening and closing body control apparatus of a fifth embodiment.

FIG. 8 is a schematic diagram of an opening and closing body control apparatus of a sixth embodiment.

FIG. 9 is a schematic diagram of an opening and closing body control apparatus of a seventh embodiment.

### DETAILED DESCRIPTIONS

### First Embodiment

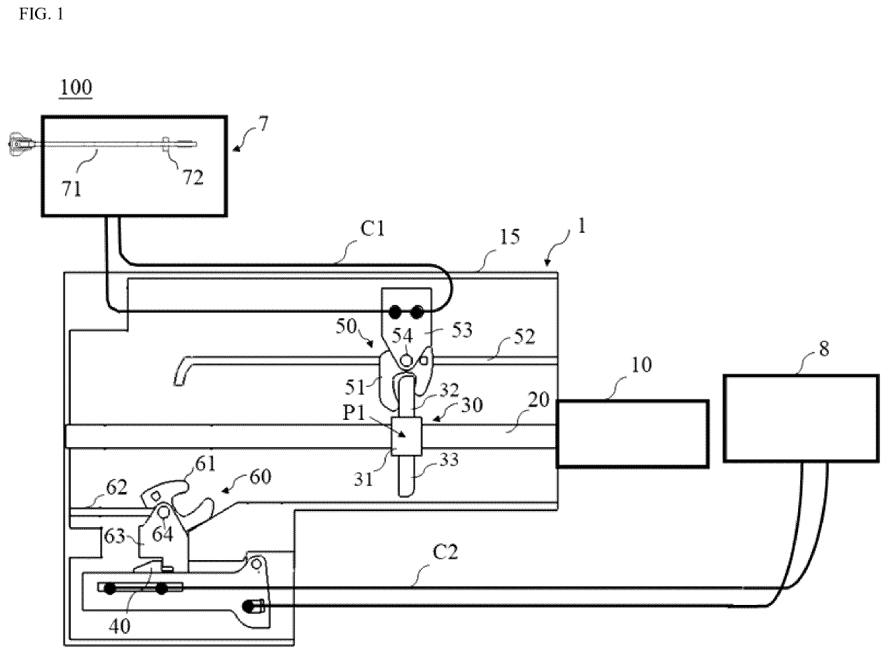

With reference to FIGS. 1 to 3, an opening and closing body control apparatus 100 of the first embodiment of the present disclosure will be described below.

As shown in FIG. 1, the opening and closing body control apparatus 100 includes a driving device 1, an opening and closing device 7, and a suction closer device 8. The opening and closing device 7 is provided on a vehicle door of a vehicle, and can perform an opening action or a closing action to open or close the vehicle door relative to a vehicle body. Here, the vehicle is an example of a moving body, the vehicle body is an example of a main body, and the vehicle door is an example of an opening and closing body. The suction closer device 8 is provided on the vehicle door, and can perform a suction action or a suction releasing action, which makes the vehicle door adhere to the vehicle body or release the adhesion of the vehicle door relative to the vehicle body. The driving device 1 is provided on the vehicle door, and is connected to the opening and closing device 7 and the suction closer device 8, and drives the opening and closing device 7 and the suction closer device 8 to operate.

The opening and closing device 7 includes a push rod 71 and a push block 72. One end of the push rod 71 is hinged to the vehicle body. The push block 72 is fixed to the push rod 71, and the push block 72 is connected to the driving device 1 via a cable C1. Although the specific connection is not shown in the figures, the connection between the push block 72 and the cable C1 can be implemented by any known method, as long as the push block 72 can accept the force of the cable C1. While the driving device 1 is working, a driving force from the driving device 1 acts on the push block 72 via the cable C1, the push block 72 is applied with a force toward or away from the vehicle body, then the force is applied to the push rod 71 and acts on the vehicle body, and the reaction force from the vehicle body is used to open or close the vehicle door.

The driving device 1 includes a screw rod 20, a nut block 30, a suction slider 40, a first engaging mechanism 50, a second engaging mechanism 60, a housing 15, and a driving motor 10. The housing 15 accommodates the screw rod 20, the nut block 30, the suction slider 40, the first engaging mechanism 50, and the second engaging mechanism 60. The driving motor 10 is an example of a power source.

The screw rod 20 is fixedly connected to an output shaft of the driving motor 10, and an axis of the screw rod 20 is located on the same straight line as an axis of the output shaft of the driving motor 10. When the driving motor 10 is in motion (rotates in the forward or reversed direction), the screw rod 20 rotates by using the driving force transmitted from the driving motor 10.

The nut block 30 is provided on the screw rod 20, and a spiral line is provided inside the nut block 30, and is spirally matched with the screw rod 20 to form a nut-screw-rod pair. When the screw rod 20 rotates, the nut block 30 performs reciprocating linear motion along the screw rod 20. The nut block 30 includes a moving portion 31, a first protrusion 32, and a second protrusion 33. The moving portion 31 moves along the screw rod 20, and the first protrusion 32 protrudes from the moving portion 31 toward the first engaging mechanism 50 for a first pawl 51 described later to be engaged with or disengaged from the first pawl 51. The second protrusion 33 protrudes from the moving portion 31 to the second engaging mechanism 60 for a second pawl 61 described later to be engaged with or disengaged from the second pawl 61.

The suction slider 40 is connected to the suction closer device 8 via a cable C2, and the suction closer device 8 is driven to perform a suction action or an suction releasing action by the movement of the suction slider 40. Any known structure such as an automatic suction lock may be applied as the suction closer device 8.

The first engaging mechanism 50 includes a first pawl 51, a first guide rail 52, and a first connecting member 53. The first engaging mechanism 50 is connected to the opening and closing device 7, and specifically, the first connecting member 53 is connected to the push block 72 of the opening and closing device 7 via the cable C1. In addition, the first pawl 51 is rotatably connected to the first connecting member 53 via a first connecting shaft 54. In other words, the first pawl 51 can rotate around the first connecting shaft 54. As a result, the first pawl 51 can slide rotatably along the first guide rail 52.

The second engaging mechanism 60 includes a second pawl 61, a second guide rail 62, and a second connecting member 63. The second connecting member 63 abuts against the suction slider 40. The second pawl 61 is rotatably connected to the second connecting member 63 via a second connecting shaft 64. In other words, the second pawl 61 can rotate around the second connecting shaft 64. As a result, the second pawl 61 can slide rotatably along the second guide rail 62. When the second pawl 61 slides, the second engaging mechanism 60 pushes the suction slider 40 to move together.

In other words, the driving device 1 is connected to both the opening and closing device 7 and the suction closer device 8, and is driven by the same driving motor 10 to operate the opening and closing device 7 and the suction closer device 8. In particular, the driving device 1 utilizes the driving force transmitted from the driving motor 10 to sequentially perform the suction releasing action of the suction closer device 8 and the opening action of the opening and closing device 7, or to sequentially perform the closing action of the opening and closing device 7 and the suction action of the suction closer device 8.

Due to the fact that the opening and closing body control apparatus 100 with the above structure can drive the opening and closing device 7 and the suction closer device 8 to perform the opening and closing actions and the suction action of the opening and closing body respectively by the same driving motor 10, he opening and closing body control apparatus 100 only needs to be provided with one driving motor 10. Compared with the opening and closing body control apparatus using the opening and closing device with its own motor and the suction closer device with its own motor, the overall opening and closing body control apparatus can be miniaturized, and the cost of components can be reduced, thereby reducing the total cost of the opening and closing body control apparatus.

With reference to FIGS. 1 to 3, the operation of the opening and closing body control apparatus 100 is described below in detail. FIGS. 1, 2 and 3 respectively show the opening and closing body control apparatus 100 when the vehicle door is in an open state (maximum opening), the vehicle door is in a state where it is closed and not adhered to vehicle body, and the vehicle door is in a state where it is closed and adhered to vehicle body.

As shown in FIGS. 1 to 3, the nut block 30 can move among a first position P1, a second position P2, and a third position P3 along the screw rod 20.

First, as shown in FIG. 1, when the vehicle door is in an open state with a maximum opening, the nut block 30 is located at the first position P1. In this case, the first pawl 51 in the first engaging mechanism 50 is engaged with the first protrusion 32 of the nut block 30, and the first pawl 51 is located at one end of a stroke of the first pawl 51 on the first guide rail 52, and the second pawl 61 in the second engaging mechanism 60 is not engaged with the second protrusion 33 of the nut block 30, and the second pawl 61 is located at one end of a stroke of the second pawl 61.

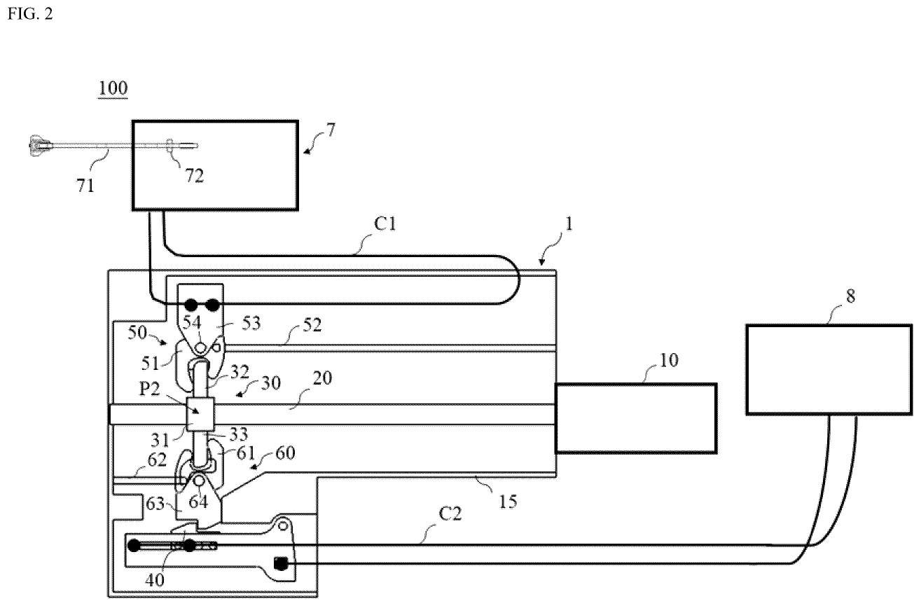

Then, in order to close the vehicle door, the opening and closing body control apparatus 100 rotates the driving motor 10 in the forward direction. Due to the driving force transmitted from the driving motor 10 to the screw rod 20, the nut block 30 moves from the first position P1 to the second position P2 along the first guide rail 52. During this period, the first pawl 51 maintains the state of being engaged with the first protrusion 32 of the nut block 30. Because the first pawl 51 continues to be engaged with the first protrusion 32 during this period, the first pawl 51 slides on the first guide rail 52 as the nut block 30 moves, thereby applying force to the push block 72 of the opening and closing device 7 via the cable C1. In this way, the driving force of the driving motor 10 is transmitted to the opening and closing device 7, which performs a closing action to change the vehicle door from an open state to a closed state. As shown in FIG. 2, when the nut block 30 is at the second position P2, the first pawl 51 is at the other end of its stroke. In this case, the second pawl 61 is still at one end of its stroke.

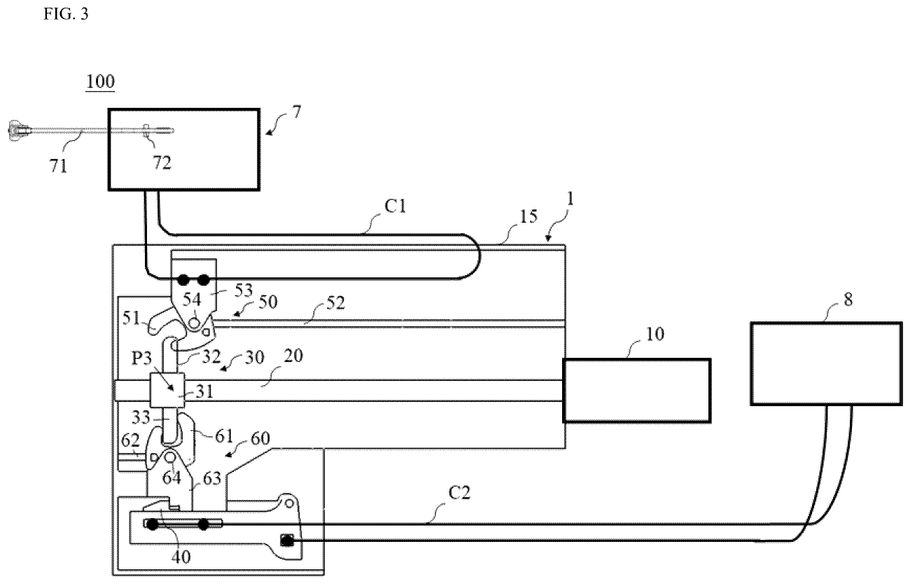

After the vehicle door is closed, in order to make the vehicle door adhere to the vehicle body, the opening and closing body control apparatus 100 continues to rotate the driving motor 10 in the forward direction, and the nut block 30 moves further from the second position P2 to the third position P3. During this period, because the first pawl 51 is already at the other end of its stroke when the first pawl 51 is located at the second position P2, the first pawl 51 cannot move further together with the nut block 30. Therefore, as the nut block 30 moves further, the first pawl 51 rotates around the first connecting shaft 54, and the first protrusion 32 of the nut block 30 begins to be disengaged from the first pawl 51. On the other hand, the second pawl 61 begins to be engaged with the second protrusion 33 of the nut block 30 and starts to move from one end of its stroke. The second pawl 61 abuts against the suction slider 40 and pushes the suction slider 40 to start sliding together. Therefore, when the second pawl 61 is engaged with the second protrusion 33, the driving force from the driving motor 10 is transmitted to the suction closer device 8 via the suction slider 40 and the cable C2, and the suction closer device 8 performs a suction action to make the vehicle door adhere to the vehicle body. As shown in FIG. 3, when the nut block 30 is located at the third position P3, the first pawl 51 is still not engaged with the nut block 30 and is at the other end of the stroke of the first pawl 51, and the second pawl 61 is engaged with the second protrusion 33 of the nut block 30 and is at the other end of the stroke of the second pawl 61.

When the driving motor 10 rotates in a reversed direction, the nut block 30 moves from the third position P3 to the second position P2 and the first position P1. During this period, the suction slider 40 returns due to the elastic force of the spring (not shown), and the suction closer device 8 performs the suction releasing action. When the nut block 30 reaches the second position P2, the first protrusion 32 begins to be engaged with the first pawl 51 again, and the driving force of the driving motor 10 is transmitted to the opening and closing device 7 again via the first engaging mechanism 50, so that the closing device 7 performs the opening action to change the vehicle door from the closed state to the open state.

According to the driving device 1 as described above, the same driving motor can be used to achieve the opening/closing and the suction/suction releasing of the vehicle door. Moreover, the opening and closing body control apparatus 100 with such a driving device 1 can achieve the transmission of driving force to the opening and closing device 7 and the suction closer device 8 through a simple structure, so that the opening and closing device 7 and the suction closer device 8 can sequentially perform the closing action and the suction action, or sequentially perform the suction releasing action and the opening action.

### Second Embodiment

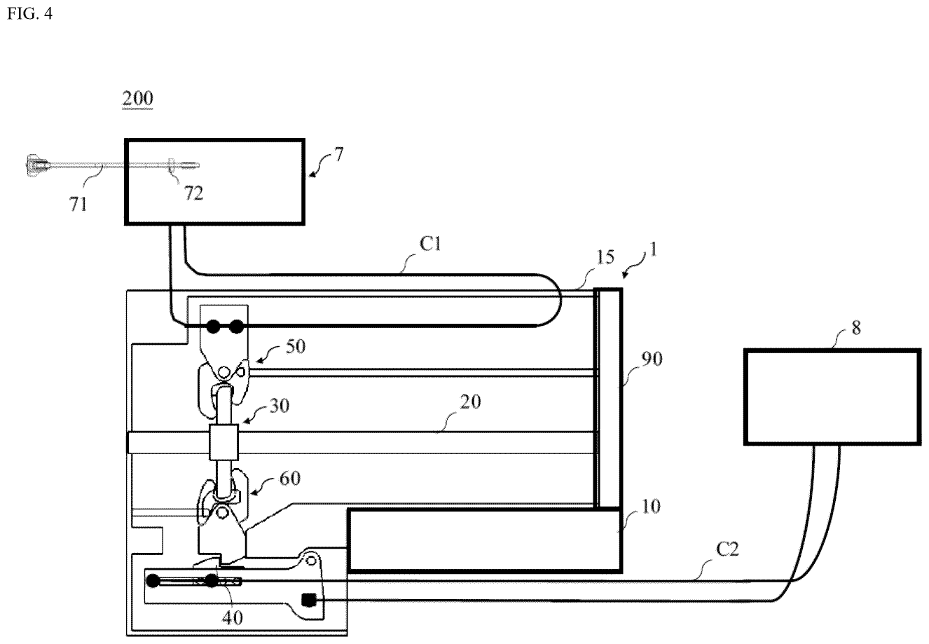

With reference to FIG. 4, an opening and closing body control apparatus 200 of the second embodiment will be described. The following mainly describes the difference between the second embodiment and the first embodiment. For parts that are the same as the first embodiment, the same symbols are used and description is omitted.

The opening and closing body control apparatus 200 includes a gear transmission part 90, and the gear transmission part 90 is arranged at one axial end of the screw rod 20 and is fixedly connected to the output shaft of the driving motor 10. When the output shaft of the driving motor 10 rotates, the driving force is transmitted to the screw rod 20 via the gear transmission part 90.

In the second embodiment, the driving motor 10 is arranged so that the output shaft of the driving motor 10 is parallel to the output shaft of the screw rod 20. Specifically, the driving motor 10 and the suction slider 40 are arranged on the same side of the screw rod 20 in an up-down direction of the vehicle, for example, both are arranged on the lower side of the screw rod 20.

The remaining part of the opening and closing body control apparatus 200 is the same as that of the opening and closing body control apparatus 100. Thus, in addition to being able to achieve the same effects as the first embodiment, the configuration freedom of the driving motor 10 can also be improved. In addition, the space below the screw rod 20 can be fully utilized to make the layout of the opening and closing body control apparatus 200 more compact.

### Third Embodiment

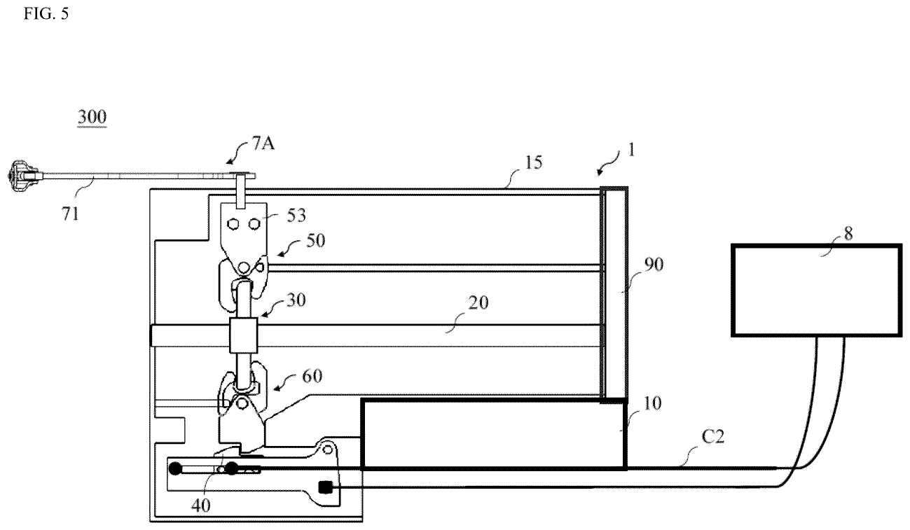

With reference to FIG. 5, an opening and closing body control apparatus 300 of the third embodiment will be described. The following mainly describes the difference between the third embodiment and the second embodiment. For parts that are the same as the second embodiment, the same symbols are used and description is omitted.

In the third embodiment, an opening and closing device 7A is used instead of the opening and closing device 7. The opening and closing device 7A does not have a push block. One end of the push rod 71 is hinged to the vehicle body and the other end is directly fixed to the first connecting member 53 of the first engaging mechanism 50. The remaining part of the opening and closing body control apparatus 300 is the same as that of the opening and closing body control apparatus 200.

In this way, in addition to being able to achieve the same effects as the first and second embodiments, it is also possible to omit the cable. This makes the opening and closing body control apparatus more compact and further reduces costs.

### Fourth Embodiment

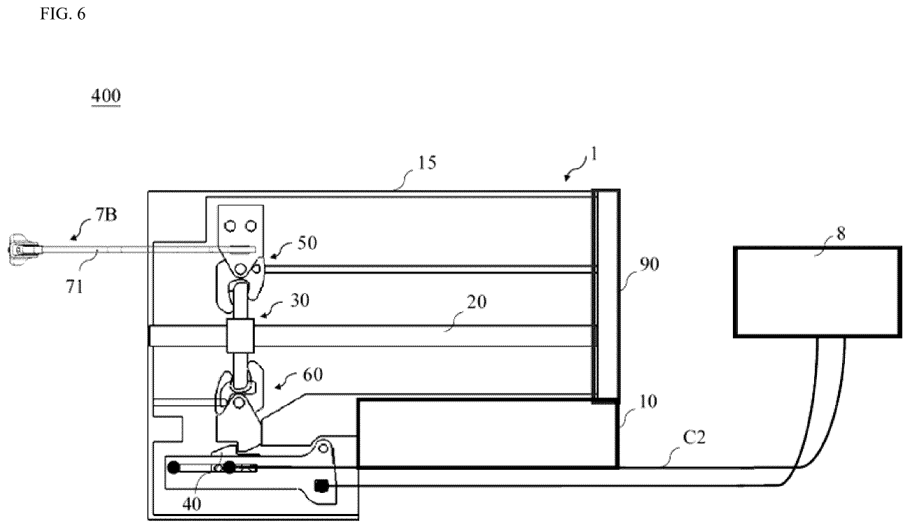

With reference to FIG. 6, an opening and closing body control apparatus 400 of the fourth embodiment will be described. The following mainly describes the difference between the fourth embodiment and the third embodiment. For parts that are the same as the third embodiment, the same symbols are used and description is omitted.

The main difference between the fourth embodiment and the third embodiment is that an opening and closing device 7B is used instead of the opening and closing device 7A. The push rod 71 of the opening and closing device 7A is entirely located outside the housing 15, while in the opening and closing device 7B, the part of the push rod 71 away from the vehicle body extends into the interior of the housing 15. The remaining part of the opening and closing body control apparatus 400 is the same as that of the opening and closing body control apparatus 300.

In this way, in addition to being able to achieve the same effect as the third embodiment, the space occupied by the opening and closing device can be further reduced, making the overall opening and closing body control apparatus 400 more compact and miniaturized.

### Fifth Embodiment

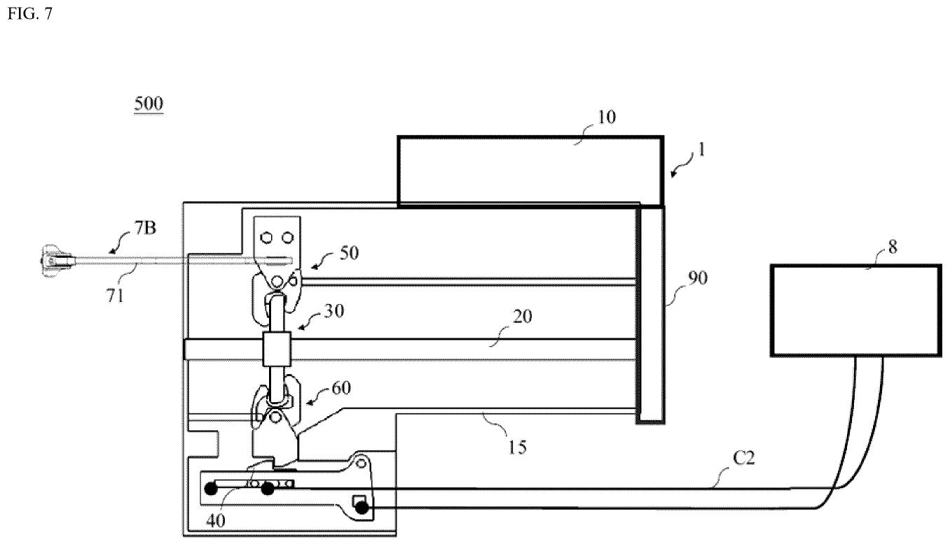

With reference to FIG. 7, an opening and closing body control apparatus 500 of the fifth embodiment will be described.

The difference between the fifth embodiment and the fourth embodiment is that in an opening and closing body control apparatus 500, the driving motor 10 and the suction slider 40 are arranged on different sides of the screw rod 20 in an up-down direction of the vehicle. For example, the suction slider 40 is arranged on the lower side of the screw rod 20, and the driving motor 10 is arranged on the upper side of the screw rod 20. The remaining part of the opening and closing body control apparatus 500 is the same as that of the opening and closing body control apparatus 400.

In this way, in addition to being able to achieve the same effect as the fourth embodiment, because a variety of components are installed on the vehicle door, when other components are arranged below the driving device 1, it is possible to prevent the driving motor from interfering with other components or affecting the operation of other components.

### Sixth Embodiment

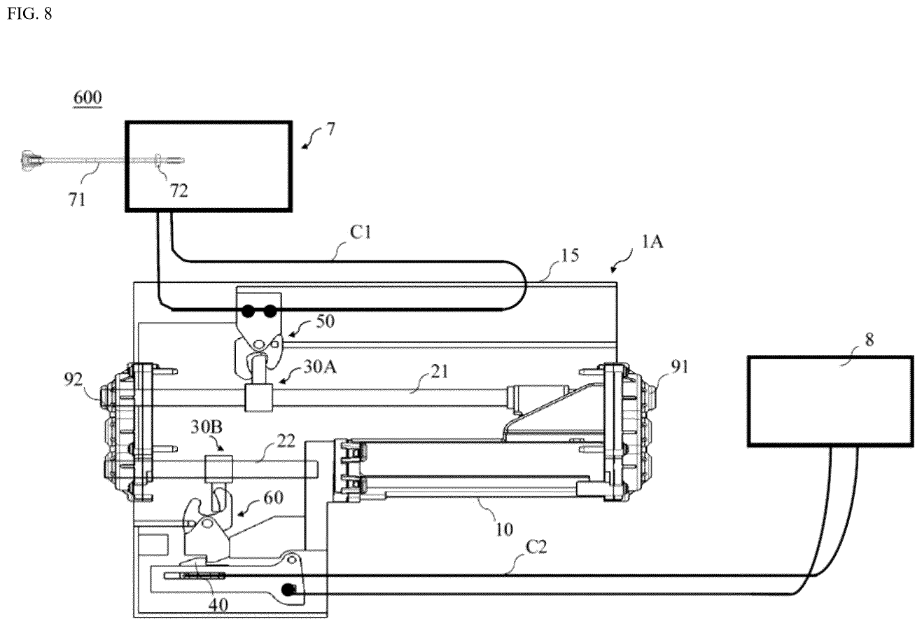

With reference to FIG. 8, an opening and closing body control apparatus 600 of the sixth embodiment will be described. The following mainly describes the difference between the sixth embodiment and the second embodiment. For parts that are the same as the second embodiment, the same symbols are used and description is omitted.

The main difference between the sixth embodiment and the second embodiment is that a driving device 1A is used instead of the driving device 1.

In the driving device 1A, the screw rod includes a first screw rod 21 and a second screw rod 22, an axis of the first screw rod 21 is parallel to an axis of the second screw rod 22, and a length and a thread pitch of the second screw rod 22 are different from those of the first screw rod 21. In addition, the gear transmission part includes a first gear transmission part 91 and a second gear transmission part 92, the first gear transmission part 91 is provided at one axial end of the first screw rod 21 and the second screw rod 22, and the second gear transmission part 92 is provided at the other axial end of the first screw rod 21 and the second screw rod 22. In addition, the nut block includes a first nut block 30A and a second nut block 30B, the first nut block 30A is provided on the first screw rod 21, and the second nut block 30B is provided on the second screw rod 22. The first nut block 30A can be engaged with the first engaging mechanism 50, and the second nut block 30B can be engaged with the second engaging mechanism 60.

The output shaft of the driving motor 10 is connected to the first gear transmission part 91, and the driving force of the driving motor 10 is transmitted to the first screw rod 21 via the first gear transmission part 91, so that the first screw rod 21 rotates. This causes the driving force being transmitted to the second gear transmission part 92, and then transmitted to the second screw rod 22 by the second gear transmission part 92, so that the second screw rod 22 rotates.

The working principle of the driving device 1A is the same as that of the driving device 1, thereby omitting the specific description here. Because the length and thread pitch of the second screw rod 22 are configured to be different from those of the first screw rod 21, the engagement of the first nut block 30A with the first engaging mechanism 50 and the engagement of the second nut block 30B with the second engaging mechanism 60 occur at different time. As a result, the vehicle door can perform an opening action, a suction action, an suction releasing action, and a closing action in sequence.

The remaining part of the opening and closing body control apparatus 600 is the same as that of the opening and closing body control apparatus 200. In this way, the double screw rod structure can be used to achieve the same effect as the second embodiment.

### Seventh Embodiment

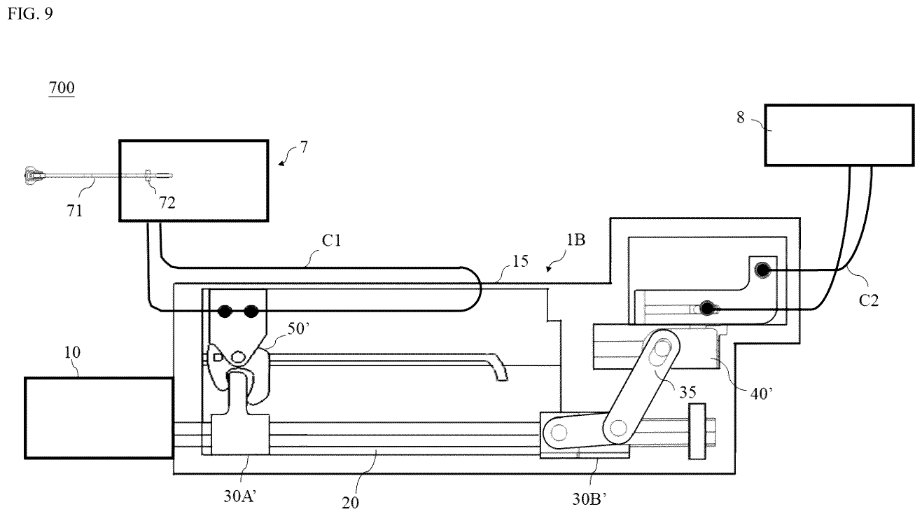

With reference to FIG. 9, an opening and closing body control apparatus 700 of the seventh embodiment will be described. The following mainly describes the difference between the seventh embodiment and the first embodiment. For parts that are the same as the first embodiment, the same symbols are used and description is omitted.

The main difference between the seventh embodiment and the first embodiment is that a driving device 1B is used instead of the driving device 1.

The driving device 1B includes a screw rod 20, a nut block 30A′, a transmission slider 30B′, a suction slider 40′, an engaging mechanism 50′, a transmission arm 35, a housing 15, and a driving motor 10. The structure of the driving motor 10, the screw rod 20, etc. is the same as that in the first embodiment. In addition, the engaging mechanism 50′is the same as the first engaging mechanism 50 in the sixth embodiment, and the nut block 30A′ is the same as the first nut block 30A in the sixth embodiment, so the description of these components is appropriately omitted.

The first nut block 30A′ is provided on the screw rod 20. When the driving motor 10 drives the screw rod 20 to rotate, the nut block 30A′ performs reciprocating linear motion along the screw rod 20.

The engaging mechanism 50′is connected to the opening and closing device 7 and can be engaged with the nut block 30A′. The specific engagement method is basically the same as the engagement of the first engaging mechanism 50 with the first nut block 30A in the sixth embodiment. During the engagement between the engaging mechanism 50′and the nut block 30A′, the driving force of the driving motor 10 is transmitted to the push rod 71 of the opening and closing device 7. During this period, when the driving motor 10 rotates in the forward direction, the opening and closing device 7 performs a closing action to change the vehicle door from the open state to the closed state. When the driving motor 10 rotates in the reversed direction, the opening and closing device 7 performs an opening action to change the vehicle door from the closed state to the open state.

No spiral line is provided inside the transmission slider 30B′, so the transmission slider 30B′ is sleeved on the screw rod 20 so as to be freely slidable thereon. When the driving motor 10 rotates in the forward direction, the screw rod 20 rotates, and the nut block 30A′ moves towards the transmission slider 30B′. Due to the forward rotation of the driving motor, the engaging mechanism 50′moves together with the nut block 30A′ to move from one end of its stroke to the other end of its stroke, and the opening and closing device 7 performs a closing action to close the vehicle door. Afterwards, the driving motor further rotates forward, the engaging mechanism 50′disengages from the nut block 30A′, and the nut block 30A′ abuts against the transmission slider 30B′.

One end of the transmission arm 35 is hinged to the transmission slider 30B′, and the other end is hinged to the suction slider 40′. There is also a force applying component (not shown) such as a spring in the housing 15, which generates a restoring force towards the nut block 30A′ on the transmission slider 30B′. When the nut block 30A′ abuts against the transmission slider 30B′, the driving force transmitted from the nut block 30A′ overcomes the restoring force, and the nut block 30A′ pushes the transmission slider 30B′ to move together. Furthermore, the driving force from the driving motor 10 is transmitted to the suction slider 40′ via the nut block 30A′, the transmission slider 30B′, and the transmission arm 35. The suction slider 40′is connected to the suction closer device 8 via a cable C2, thereby driving the suction closer device 8 to perform a suction action.

When the driving motor 10 rotates in the reversed direction, the nut block 30A′ moves away from the transmission slider 30B′, and the transmission force of the driving motor 10 is no longer transmitted to the transmission slider 30B′. The transmission slider 30B′ is returned due to the restoring force. So that the slider 40′ makes the suction closer device 8 perform the suction releasing action. Afterwards, the driving motor 10 further rotates in the reversed direction, and the nut block 30A′ engages with the engaging mechanism 50′ again, and the opening and closing device 7 performs an opening action to open the vehicle door.

According to the opening and closing body control apparatus 700 as described above, the driving force from the driving motor 10 is transmitted to the suction closer device 8 by using the transmission arm 35, thereby, the same technical effect as the first embodiment can be achieved. In addition, because the engaging mechanism 50′ driving the opening and closing device 7 and the transmission arm 35 driving the suction closer device 8 are arranged horizontally relative to a screw rod 20, the opening and closing body driving device can be made more compact in the longitudinal direction.

The embodiments of the present disclosure are described above, but the present disclosure is not limited to these examples. Any additions, deletions, design changes to the constituent elements of the above-mentioned embodiments made by those skilled in the art, or appropriate combinations of some features of the embodiments, are included in the scope of the present disclosure, as long as the spirit of the present disclosure is not violated.

In the above embodiments, the vehicle is illustrated as the moving body and the vehicle door is illustrated as the opening and closing body, but they are not particularly limited. The moving body may also be other transportation facilities such as ships, trains, aircraft, etc. And the opening and closing bodies may also be cabin doors, trunk doors, etc.

In the above embodiments, the power source is described by taking a motor as an example, but the power source is not limited to the motor. Any known power source can be used, such as batteries, manual labor, etc.

In the present disclosure, engagement and disengagement of the nut block and the engaging mechanism are implemented by means of using a pawl and a protrusion, but not limited to the embodiment. Engagement and disengagement may be implemented by another appropriate shape engagement. In the present disclosure, examples of direct connection between the driving motor and the screw rod or connection via a gear transmission part are listed, but the connection between the driving motor and the screw rod is not limited to this, a transmission, a brake, a clutch, etc. may be provided between the driving motor and the screw rod, or between the driving motor and the gear transmission part.

In the third and fourth embodiments, the other end of the push rod is directly fixed to the first engaging mechanism, and the fixing method may be arbitrary, for example, fixing may be performed by welding, hinging, etc., or fixing may be performed by fasteners.

In the sixth embodiment, it is described that the first nut block can be engaged with the first engaging mechanism, and the second nut block can be engaged with the second engaging mechanism. However, it may also be that, the first nut block can be engaged with the second engaging mechanism, and the second nut block can be engaged with the first engaging mechanism.

In the sixth embodiment, it is described that both the length and thread pitch of the second screw rod are different from those of the first screw rod, but it can also be that at least one of the length and thread pitch of the second screw rod is different from that of the first screw rod. As long as the engagement between the first nut block 30A and the first engaging mechanism 50, and the engagement between the second nut block 30B and the second engaging mechanism 60 occur at different timings, it is sufficient. Alternatively, in the sixth embodiment, the first gear transmission part 91 and the second gear transmission part 92 may have different gear ratios. With those gear ratios, the engagement between the first nut block 30A and the first engaging mechanism 50, as well as the engagement between the second nut block 30B and the second engaging mechanism 60, can also occur at different timings.

### DESCRIPTION OF SYMBOLS

100, 200, 300, 400, 500, 600, 700 . . . opening and closing body control apparatus, 1, 1A, 1B . . . driving device, 10 . . . driving motor (power source), 15 . . . housing, 20 . . . screw rod, 21 . . . the first screw rod, 22 . . . the second screw rod, 30, 30A′. . . nut block, 30A . . . the first nut block, 30B . . . the second nut block, 30B′. . . transmission slider, 31 . . . moving portion, 32 . . . the first protrusion, 33 . . . the second protrusion, 35 . . . transmission arm, 40, 40′. . . suction slider, 50 . . . the first engaging mechanism, 50′. . . engaging mechanism, 51 . . . the first pawl, 52 . . . the first guide rail, 53 . . . the first connecting member, 54 . . . the first connecting shaft, 60 . . . the second engaging mechanism, 61 . . . the second pawl, 62 . . . the second guide rail, 63 . . . the second connecting member, 64 . . . the second connecting shaft, 7, 7A, 7B . . . opening and closing device, 71 . . . push rod, 72 . . . push block, 8 . . . suction closer device, 90 . . . gear transmission part, 91 . . . the first gear transmission part, 92 . . . the second gear transmission part, C1, C2 . . . cable, P1 . . . the first position, P2 . . . the second position, P3 . . . the third position.

What is claimed is:

1. An opening and closing body control apparatus, comprising:
an opening and closing device, wherein the opening and closing device can perform an opening action or a closing action, allowing an opening and closing body of a moving body to open or close relative to a main body of the moving body;
a suction closer device, wherein the suction closing device can perform a suction action or a suction releasing action, allowing the opening and closing body adhere to the main body or release the adherence of the opening and closing body relative to the main body; and
a driving device, wherein the driving device is connected to the opening and closing device and the suction closer device, and drives the opening and closing device and the suction closer device to perform an action by the same power source, wherein
the driving device utilizes a driving force transmitted from the power source to sequentially perform the suction releasing action of the suction closer device and the opening action of the opening and closing device, or to sequentially perform the closing action of the opening and closing device and the suction action of the suction closer device.

2. The opening and closing body control apparatus according to claim 1, wherein
the driving device comprises:
a screw rod, wherein the screw rod is connected to an output shaft of the power source and rotates by a driving force transmitted from the power source;
a nut block, wherein the nut block is provided on the screw rod, and when the screw rod rotates, the nut block performs reciprocating linear motion along the screw rod;
a suction slider, wherein the suction slider is connected to the suction closer device, and drives the suction closer device to perform the suction action or the suction releasing action by the movement of the suction slider;
a first engaging mechanism, wherein the first engaging mechanism is connected to the opening and closing device, and is connected to the nut block in a manner capable of being engaged with or disengaged from the nut block, and when the first engaging mechanism is engaged with the nut block, the driving force is transmitted to the opening and closing device; and
a second engaging mechanism, wherein the second engaging mechanism abuts against the suction slider, and is connected to the nut block in a manner capable of being engaged with or disengaged from the nut block, and when the second engaging mechanism is engaged with the nut block, the nut block can drive the suction slider to move.

3. The opening and closing body control apparatus according to claim 2, wherein
the first engaging mechanism comprises a first guide rail and a first pawl that can slide rotatably along the first guide rail, and the first pawl can be engaged with or disengaged from the nut block, and
the second engaging mechanism comprises a second guide rail and a second pawl that can slide rotatably along the second guide rail, and the second pawl can be engaged with or disengaged from the nut block.

4. The opening and closing body control apparatus according to claim 3, wherein
the nut block comprises:
a moving portion, wherein the moving portion moves along the screw rod;
a first protrusion, wherein the first protrusion protrudes from the moving portion toward the first engaging mechanism for the first pawl to be engaged with or disengaged from the first pawl; and
a second protrusion, wherein the second protrusion protrudes from the moving portion toward the second engaging mechanism for the second pawl to be engaged with or disengaged from the second pawl.

5. The opening and closing body control apparatus according to claim 3, wherein
the nut block can move along the screw rod among a first position, a second position, and a third position,
when the nut block is located at the first position, the first pawl is engaged with the nut block and is located at one end of a stroke of the first pawl, and the second pawl is not engaged with the nut block and is located at one end of a stroke of the second pawl,
when the nut block is located at the second position, the first pawl begins to be disengaged from the nut block and is located at the other end of the stroke of the first pawl, and the second pawl begins to be engaged with the nut block and is located at the one end of the stroke of the second pawl, and
when the nut block is located at the third position, the first pawl is not engaged with the nut block and is at the other end of the stroke of the first pawl, and the second pawl is engaged with the nut block and is at the other end of the stroke of the second pawl.

6. The opening and closing body control apparatus according to claim 2, wherein
an axis of the output shaft of the power source and an axis of the screw rod are located on the same straight line.

7. The opening and closing body control apparatus according to claim 2, wherein
the driving device further comprises a gear transmission part, the gear transmission part is arranged at an axial end of the screw rod and is connected to the output shaft of the power source, and the driving force of the power source is transmitted to the screw rod via the gear transmission part, and
an axis of the output shaft of the power source is parallel to an axis of the screw rod.

8. The opening and closing body control apparatus according to claim 7, wherein
the power source and the suction slider are arranged on the same side of the screw rod in an up-down direction of the moving body.

9. The opening and closing body control apparatus according to claim 7, wherein
the power source and the suction slider are respectively arranged on both sides of the screw rod in an up-down direction of the moving body.

10. The opening and closing body control apparatus according to claim 7, wherein
the screw rod comprises a first screw rod and a second screw rod whose axes are parallel to each other,
the gear transmission part comprises a first gear transmission part provided at one axial end of the first screw rod and the second screw rod, and a second gear transmission part provided at the other axial end of the first screw rod and the second screw rod,
the output shaft of the power source is connected to the first gear transmission part, and the driving force of the power source is transmitted to the first screw rod via the first gear transmission part, and then transmitted to the second screw rod via the second gear transmission part,
the nut block comprises a first nut block provided on the first screw rod and a second nut block provided on the second screw rod, and
one of the first nut block and the second nut block can be engaged with the first engaging mechanism, and the other one of the first nut block and the second nut block can be engaged with the second engaging mechanism.

11. The opening and closing body control apparatus according to claim 10, wherein
the gear ratios of the first gear transmission part and the second gear transmission part are different, or,
at least one of the length and thread pitch of the second screw rod is different from that of the first screw rod.

12. The opening and closing body control apparatus according to claim 2, wherein
the opening and closing device comprises a push rod, one end of the push rod is hinged to the main body, when a force is applied to the push rod toward or away from the main body, a reaction force from the main body is used to open or close the opening and closing body,
a push block is fixed to the push rod, and the push block is connected to the first engaging mechanism via a cable, and
the driving force is transmitted to the push rod via the cable and the push block.

13. The opening and closing body control apparatus according to claim 2, wherein
the opening and closing device comprises a push rod, one end of the push rod is hinged to the main body, when a force is applied to the push rod toward or away from the main body, a reaction force from the main body is used to open or close the opening and closing body, and
the other end of the push rod is directly fixed to the first engaging mechanism.

14. The opening and closing body control apparatus according to claim 13, wherein
the driving device further comprises a housing, and the housing accommodates the power source, the screw rod, the nut block, the suction slider, the first engaging mechanism, and the second engaging mechanism, and
a part of the push rod extends into the interior of the housing.

15. The opening and closing body control apparatus according to claim 1, wherein
the driving device comprises:
a screw rod, wherein the screw rod is connected to the power source and rotates by a driving force transmitted from the power source;
a nut block, wherein the nut block is provided on the screw rod, and when the screw rod rotates, the nut block performs reciprocating linear motion along the screw rod;
a transmission slider, wherein the transmission slider is sleeved on the screw rod so as to be freely slidable thereon;
a suction slider, wherein the suction slider is connected to the suction closer device, and drives the suction closer device to perform the suction action or the suction releasing action by the movement of the suction slider;
an engaging mechanism, wherein the engaging mechanism is connected to the opening and closing device, and is connected to the nut block in a manner capable of being engaged with or disengaged from the nut block, and when the engaging mechanism is engaged with the nut block, the driving force is transmitted to the opening and closing device; and
a transmission arm, wherein one end of the transmission arm is hinged to the transmission slider, and the other end of the transmission arm is hinged to the suction slider, wherein
when the nut block moves and abuts against the transmission slider, the transmission slider moves along the screw rod together with the nut block, and the driving force is transmitted from the transmission slider to the suction slider through the transmission arm, and when the nut block moves away from the transmission slider, the transmission slider is returned due to a restoring force.

16. An opening and closing body, wherein
an opening and closing body control apparatus according to claim 1 is provided.
